(19) United States
(12) Patent Application Publication
(10) Pub. No.: US 2009/0178680 A1
(43) Pub. Date: Jul. 16, 2009

(54) HEAD STRAP

(76) Inventor: Eric Chang, Taichung Hsien (TW)

Correspondence Address: CHRISTIE, PARKER & HALE, LLP, PO BOX 7068, PASADENA, CA, 91109-7068, US

(21) Appl. No.: 12/014,066

(22) Filed: Jan. 14, 2008

(51) Int. Cl. A62B 18/08

(52) U.S. Cl. 128/206.27; 128/207.11

(57) ABSTRACT

A head strap includes a curved top strap portion having left and right ends, and left and right connecting strap portions extending downwardly and respectively from the left and right ends of the top strap portion and having bottom ends connected to each other below the top strap portion. The top strap portion and the left and right connecting strap portions cooperatively confine a substantially triangular through hole. The head strap further includes left and right top pull straps inclining upwardly and respectively from the left and right ends of the top strap portion, and left and right bottom pull straps inclining upwardly and respectively from the bottom ends of the left and right connecting strap portions. Each of the top and bottom pull straps forms an acute angle with respect to an axis of symmetry of a main body of the head strap.

### BACKGROUND OF THE INVENTION

1. Field of the Invention

This invention relates to a head strap, more particularly to a head strap that is suitable for use by a user wearing an anesthesia or a respiratory mask.

2. Description of the Related Art

Referring to FIGS. 1 to 3, a conventional head strap 10 that is suitable for use by a user 30 wearing an anesthesia or a respiratory mask 20 is made of an elastic material, and has symmetrical left and right sides. The head strap 10 includes a main body 11, left and right top pull straps 13, 12 extending outwardly and horizontally from a top portion 111 of the main body 11, and left and right bottom pull straps 15, 14 extending outwardly and horizontally from a bottom portion 112 of the main body 11. The main body 11 further has a curved top strap portion 17 interconnecting the top pull straps 13, 12, a left connecting strap portion 18 interconnecting fixed ends of the left top and bottom pull straps 13, 15, a right connecting strap portion 18′ interconnecting fixed ends of the right top and bottom pull straps 12, 14, and a through hole 16 confined by the curved top strap portion 17 and the left and right connecting strap portions 18, 18′.

In use, free ends of the top and bottom pull straps 12, 13, 14, 15 are connected to the mask 20, after which an assembly of the head strap 10 and the mask 20 is sleeved on the head 31 of the user 30 with the through hole 16 located between the border of the occipital bone 32 and the top bone 33 of the user's head 31. The mask 20 is then pulled forwardly so as to cover the user's nose 34 and mouth 35.

Although the conventional head strap 10 can achieve its intended purpose, it has the following drawbacks:

Because each of the top pull straps 12, 13 forms a right angle δ with an axis of symmetry (1) of the head strap 10, when the top pull straps 12, 13 are fastened tightly between the mask 20 and the head 31 of the user 30, the tightening force is concentrated at junctions 19 between two opposite ends of the top strap portion 17 and the respective top pull straps 12, 13, and cannot be transmitted effectively to the top strap portion 17. Hence, the top strap portion 17 is in a loose state during a normal use of the head strap 10, as best shown in FIG. 2. With reference to FIG. 3, in combination with FIG. 2, although the top pull straps 12, 13 are inclined downwardly with respect to the mask 20 and can pull the top strap portion 17 toward the head 31 by an angular displacement (L1), the downward pulling force thereof is insufficient to press the top strap portion 17 against the top bone 33. As such, a gap exists between the top strap portion 17 and the top bone 33.

Referring to FIG. 4, in combination with FIG. 1, the conventional head strap 10 may also be used in combination with an anesthesia or a respiratory mask 20′ that covers only the nose 34 of the user 30. In this case, the top pull straps 12, 13 are fastened to the mask 20′ in an almost horizontal manner, so that the top strap portion 17 cannot be pulled forwardly to abut against the top bone 33. As such, the possibility of the top strap portion 17 being completely spaced apart from the top bone 33 is high. One consequence of this is that relative movement between the head 31 and a pillow may result in the release of the entire mask 20′ from the nose 34 of the user 30.

Comparing the two applications of the conventional head strap 10 shown in FIGS. 2 and 4, it is apparent that the larger the inclination angle β1 (see FIG. 3) of the top pull straps 12, 13 relative to the connection point of the head strap 10 with the mask 20, 20′, the greater the distance that the top strap portion 17 can move forwardly toward the top bone 33 of the user 30 (see the phantom lines in FIG. 3). However, the inclination angle β1 of the head strap 10 relative to the mask 20, 20′ depends upon the connecting position of the head strap 10 and the mask 20, 20′. Thus, the head strap 10 is unable to provide the same positioning effect for the mask 20 that covers both the user's nose 34 and mouth 35 as it does for the mask 20′ that covers only the user’s nose 34.

### SUMMARY OF THE INVENTION

Therefore, the object of the present invention is to provide a head strap that is suitable for use by a user wearing an anesthesia or a respiratory mask and that is capable of overcoming the aforementioned drawbacks of the prior art.

According to this invention, a head strap is suitable for use by a user wearing an anesthesia or a respiratory mask, and is made of an elastic material. The head strap comprises a main body that includes a curved top strap portion having left and right ends, and left and right connecting strap portions extending downwardly and respectively from the left and right ends of the top strap portion and having bottom ends connected to each other below the top strap portion. The top strap portion and the left and right connecting strap portions cooperatively confine a substantially triangular through hole. The head strap further includes left and right top pull straps inclining upwardly and respectively from the left and right ends of the top strap portion while extending away from the main body, and left and right bottom pull straps inclining upwardly and respectively from the bottom ends of the left and right connecting strap portions while extending away from the main body. Each of the left and right top pull straps forms an acute angle with respect to an axis of symmetry of the main body. Each of the left and right bottom pull straps forms an acute angle with respect to the axis of symmetry.

### BRIEF DESCRIPTION OF THE DRAWINGS

Other features and advantages of the present invention will become apparent in the following detailed description of the preferred embodiments of the invention, with reference to the accompanying drawings, in which:

FIG. 1 is a schematic view of a conventional head strap;

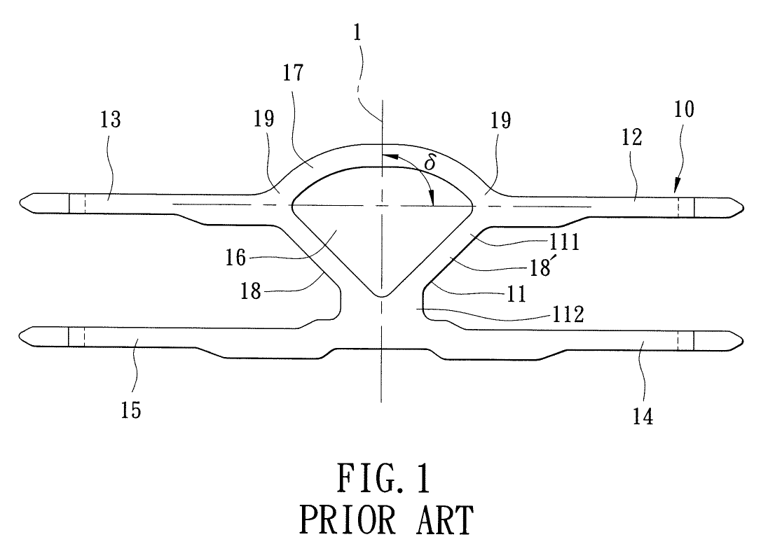

FIG. 2 is a perspective view of the conventional head strap in a state of use;

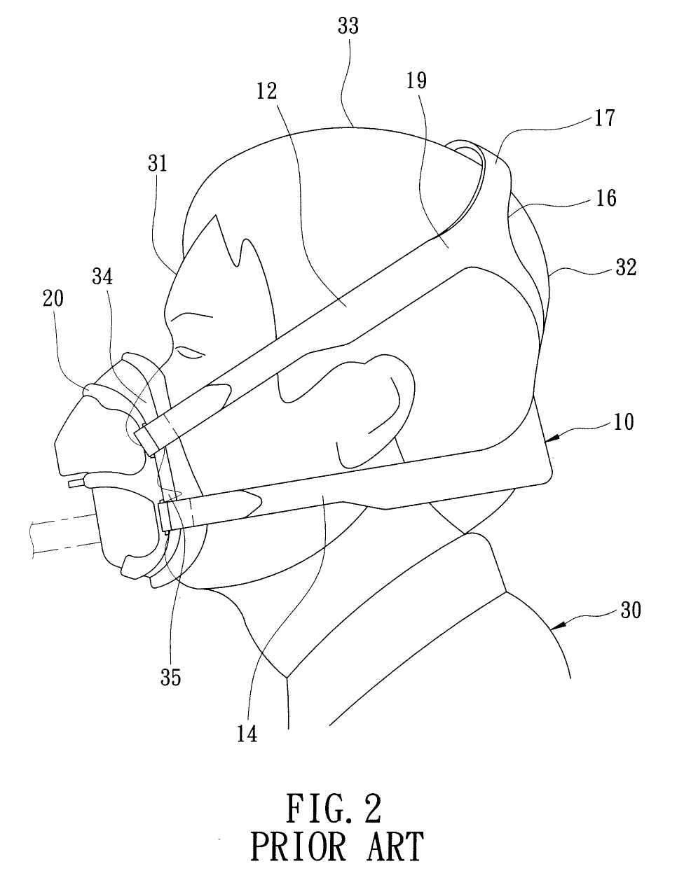

FIG. 3 illustrates how a top strap portion of the conventional head strap displaces during use of the same;

FIG. 4 illustrates another use of the conventional head strap;

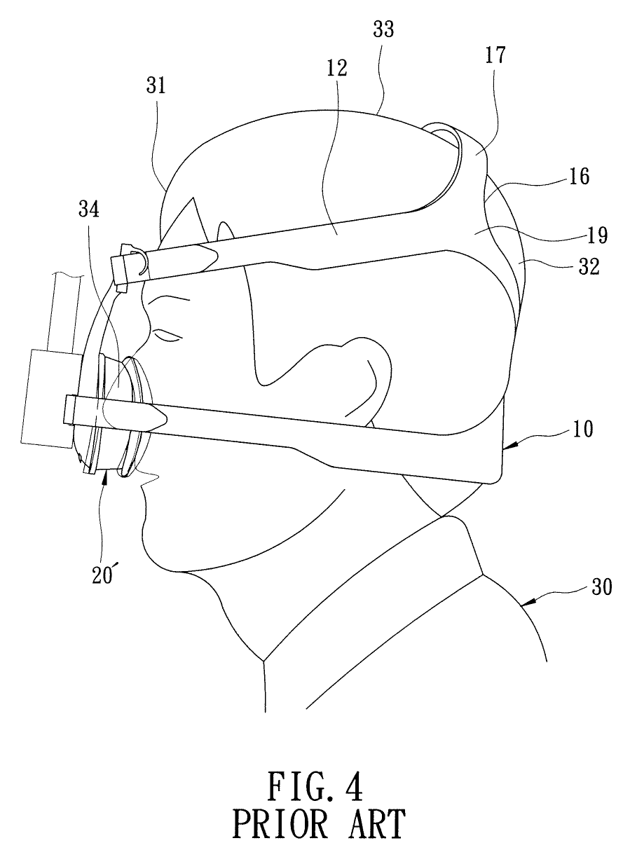

FIG. 5 is a schematic view of a head strap according to the first preferred embodiment of the present invention;

FIG. 6 is a perspective view of the first preferred embodiment in a state of use;

FIG. 7 illustrates how straps of the first preferred embodiment move during use of the head strap of the present invention;

FIG. 8 is a schematic view of a head strap according to the second preferred embodiment of the present invention; and

FIG. 9 is a perspective view of the second preferred embodiment in a state of use.

### DETAILED DESCRIPTION OF THE PREFERRED EMBODIMENTS

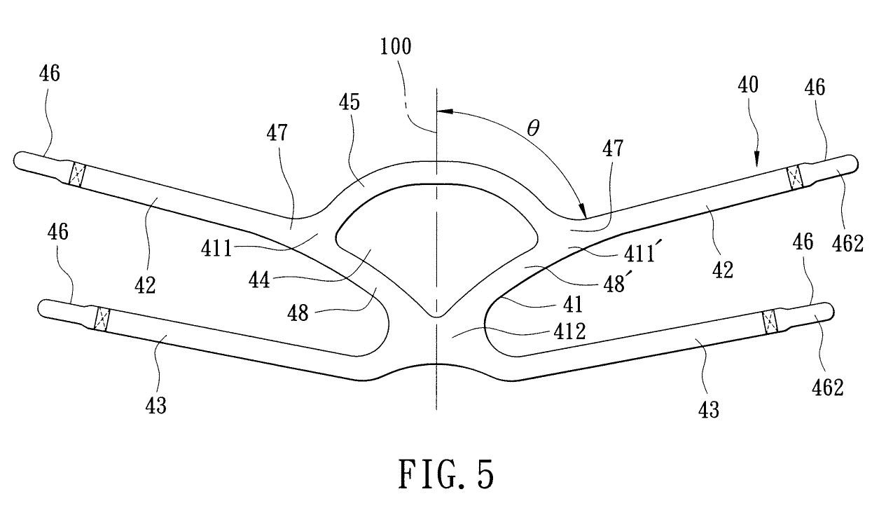

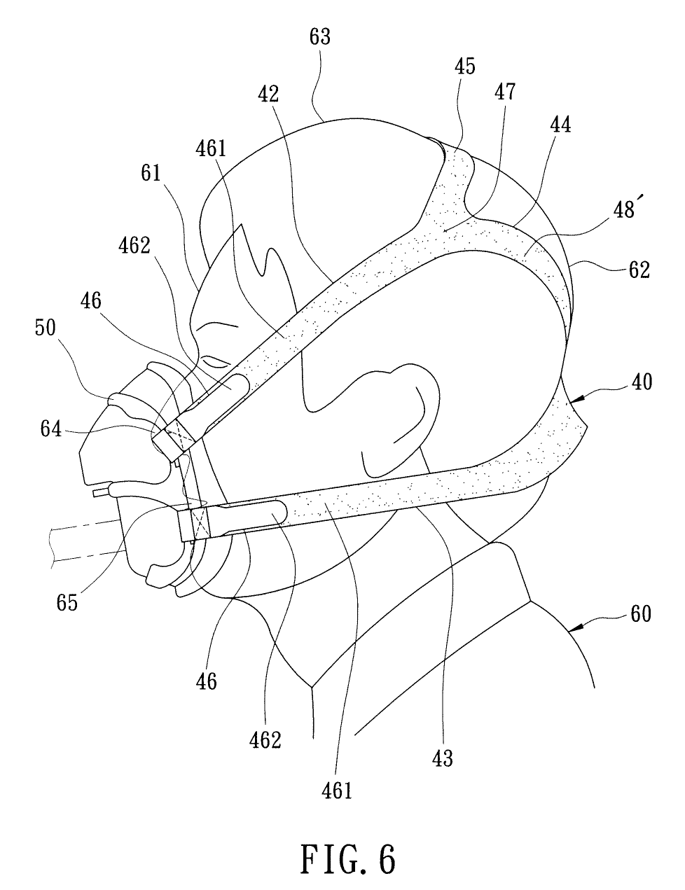

Referring to FIGS. 5 to 7, a head strap 40 according to the first preferred embodiment of the present invention is made of an elastic material, is suitable for use by a user wearing an anesthesia or a respiratory mask 50, and is shown to comprise a main body 41. The main body 41 has an axis of symmetry 100, and includes a curved top strap portion 45 having left and right ends 411, 411′, and left and right connecting strap portions 48, 48′ extending downwardly and respectively from the left and right ends 411, 411′ of the top strap portion 45 and having bottom ends 412 connected to each other below the top strap portion 45. The top strap portion 45 and the left and right connecting strap portions 48, 48′ cooperatively confine a substantially triangular through hole 44.

The main body 41 further includes left and right top pull straps 42 inclining upwardly from the left and right ends 411, 411′ of the top strap portion 45 while extending away from the main body 41 and forming an acute angle θ with the axis of symmetry 100, and left and right bottom pull straps 43 inclining upwardly and respectively from the bottom ends 412 of the left and right connecting strap portions 48, 48′ while extending away from the main body 41 and forming an acute angle θ with the axis of symmetry 100. The acute angle θ, in this embodiment, has a range of 45°˜80°.

Four releasable fasteners 46 are provided respectively on the left and right top and bottom pull straps 42, 43. Each of the releasable fasteners 46 includes a hook fastening strap 462 provided on the free end of a respective one of the left and right top and bottom pull straps 42, 43, and a loop fastening strap 461 provided on an outer surface of the respective one of the left and right top and bottom pull straps 42, 43.

In use, the free ends of the left and right top and bottom pull straps 42, 43 are first inserted respectively into a plurality of holes in the mask 50, and are then folded so as to interengage releasably the hook and loop fastening straps 462, 461 of the releasable fasteners 46, thereby completing assembly of the head strap 40 and the mask 50. Subsequently, the assembly of the head strap 40 and the mask 50 is sleeved on the head 61 of a user 60 by centering the through hole 44 of the head strap 40 between the border of the occipital bone 62 and the top bone 63 of the user's head 61, after which the mask 50 is placed over the user's nose 64 and mouth 65.

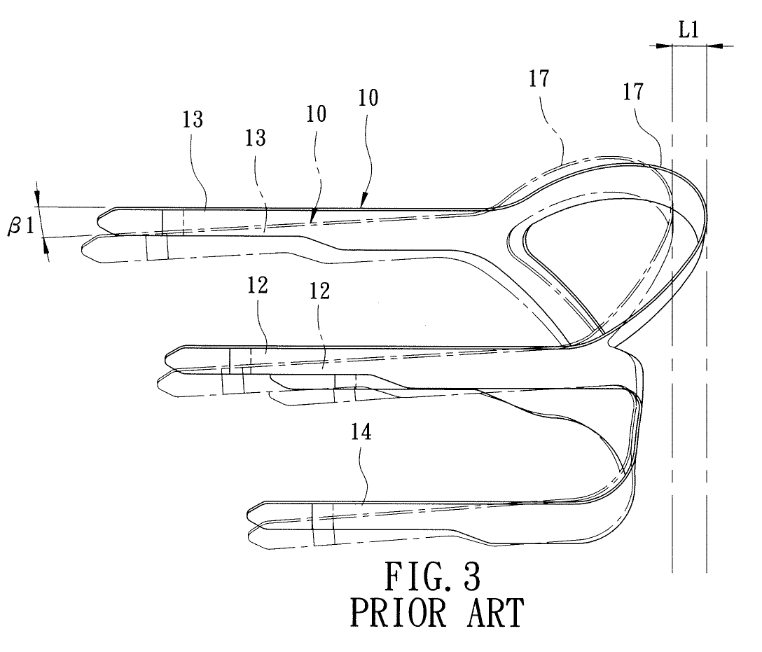

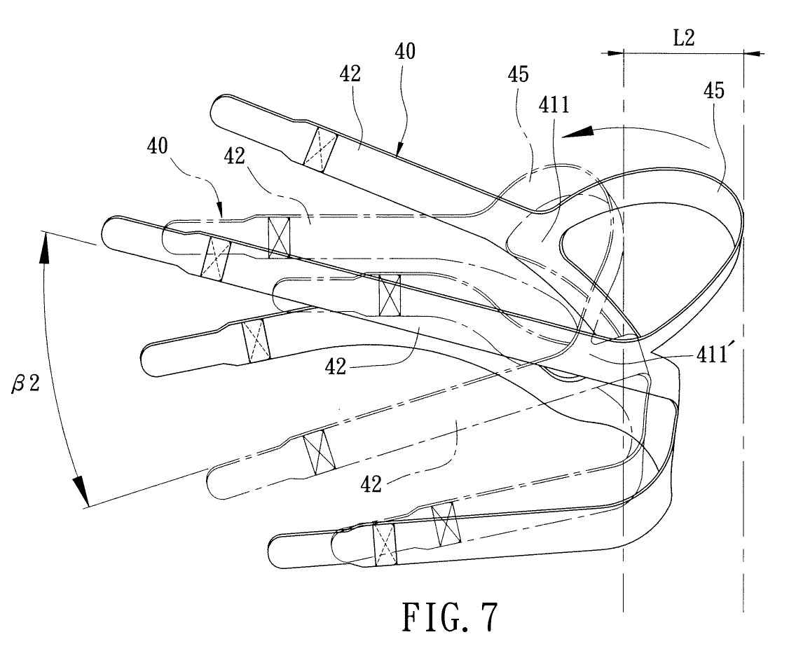

It is worth mentioning that because the left and right top pull straps 42 extend inclinedly, upwardly, and respectively from the left and right ends 411, 411′ of the top strap portion 45, when the mask 50 is placed over the user's nose 64 and mouth 65, the left and right top pull straps 42 are pulled forwardly and inclined downwardly by a larger inclining angle β2 (see FIG. 7) as compared to the inclining angle β1 of the top pull straps 12, 13 of the conventional head strap 10, as shown in FIG. 3. Due to the larger inclining angle β2 of the top pull straps 42, the top strap portion 45 can be pulled by the left and right top pull straps 42 to move toward the top bone 63 by an increased angular displacement (L2), and a large downward pulling force is produced to pull downwardly the top strap portion 45 and junctions 47 between the left and right ends 411, 411′ of the top strap portion 45 and the respective top pull straps 42, so that the top strap portion 45 can be pressed tightly against the top bone 63 of the user 60. Hence, the function of the top strap portion 45 is enhanced, and the mask 50 can be effectively positioned.

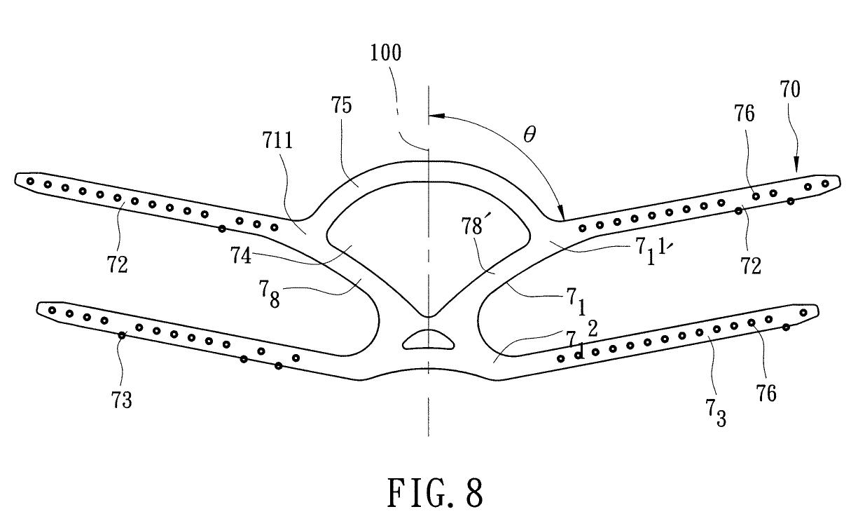

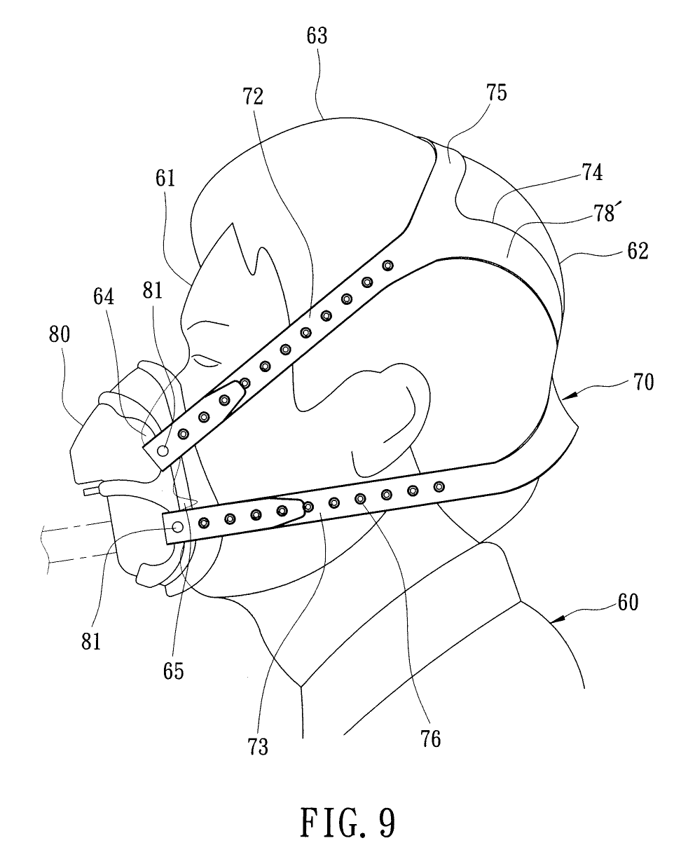

Referring to FIGS. 8 and 9, a head strap 70 according to the second preferred embodiment of the present invention is shown to be similar to the first preferred embodiment. Particularly, the head strap 70 includes a main body 71 having an axis of symmetry 100. The main body 71 includes a curved top strap portion 75, left and right connecting strap portions 78, 78′ extending downwardly and respectively from left and right ends 711, 711′ of the top strap portion 75 and having bottom ends 712 connected to each other below the top strap portion 75, left and right top pull straps 72 inclining upwardly from the left and right ends 711, 711′ of the top strap portion 75 and forming an acute angle θ with the axis of symmetry 100, and left and right bottom pull straps 73 inclining upwardly and respectively from the bottom ends 712 of the left and right connecting strap portions 78, 78′ and forming an acute angle θ with the axis of symmetry 100. The top strap portion 75 and the left and right connecting strap portions 78, 78′ cooperatively confine a substantially triangular through hole 74. The acute angle θ, in this embodiment, also ranges from 45°˜80°.

The difference between the head straps 40, 70 of the first and second preferred embodiments resides in that each of the top and bottom pull straps 72, 73 is formed with a plurality of engaging holes 76 in the second preferred embodiment.

In use, the free ends of the top and bottom pull straps 72, 73 are first inserted respectively into a plurality of holes in an anesthesia or a respiratory mask 80, and are then folded after being pulled through the holes by a predetermined desired amount. Finally, the engaging holes 76 are engaged releasably with respective studs 81 provided on the mask 80, thereby completing assembly of the head strap 70 and the mask 80. Subsequently, the assembly of the head strap 70 and the mask 80 is sleeved on the head 61 of a user 60 by centering the through hole 74 of the head strap 70 between the border of the occipital bone 62 and the top bone 63 of the user's head 61, after which the mask 80 is placed over the user's nose 64 and mouth 65. The top strap portion 75 can similarly make a large angular displacement (L2) (see FIG. 7) when the top pull straps 72 are pulled forwardly and downwardly, so that the top strap portion 75 can abut tightly against the top bone 63 of the user 60.

While the present invention has been described in connection with what are considered the most practical and preferred embodiments, it is understood that this invention is not limited to the disclosed embodiments but is intended to cover various arrangements included within the spirit and scope of the broadest interpretations and equivalent arrangements.

I claim:

1. A head strap suitable for use by a user wearing an anesthesia or a respiratory mask and made of an elastic material, said head strap comprising:
a main body including a curved top strap portion having left and right ends, and left and right connecting strap portions extending downwardly and respectively from said left and right ends of said top strap portion and having bottom ends connected to each other below said top strap portion, said top strap portion and said left and right connecting strap portions cooperatively confining a substantially triangular through hole, said head strap further including left and right top pull straps inclining upwardly and respectively from said left and right ends of said top strap portion while extending away from said main body, and left and right bottom pull straps inclining upwardly and respectively from said bottom ends of said left and right connecting strap portions while extending away from said main body, each of said left and right top pull straps forming an acute angle with respect to an axis of symmetry of said main body, each of said left and right bottom pull straps forming an acute angle with respect to said axis of symmetry.

2. The head strap of claim 1, wherein each of said acute angles of said left and right top and bottom pull straps has a range of 45°˜80°.

3. The head strap of claim 1, further comprising releasable fasteners provided respectively on said left and right top and bottom pull straps.

4. The head strap of claim 3, wherein each of said releasable fasteners includes hook and loop fastening straps.

5. The head strap of claim 1, wherein each of said top and bottom pull straps is provided with a plurality of engaging holes adapted to engage the anesthesia or respiratory mask.
